(19) United States
(12) Patent Application Publication
(10) Pub. No.: US 2008/0071446 A1
(43) Pub. Date: Mar. 20, 2008

(54) Method for Controlling a Safety-Relevant Component of a Motor Vehicle and Motor Vehicle Comprising a Preventively Activated Safety System

(75) Inventors: Horst Brauner, Steinenbronn (DE); Lutz Kiessling, Sindelfingen (DE); Hans Roehm, Wildberg (DE); Wolfgang Schindler, Weil der Stadt (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/587,819

(22) PCT Filed: Apr. 21, 2005
(86) PCT No.: PCT/EP05/04294

§ 371 Date: Aug. 28, 2007

(30) Foreign Application Priority Data
Apr. 30, 2004 (DE) 10 2004 021 174.4

(51) Int. Cl. G05D 3/00; B60K 28/14

(52) U.S. Cl. 701/45; 180/282

(57) ABSTRACT

The invention relates to a method for controlling at least one safety-related component of a motor vehicle, in particular of a passenger car, as a function of vehicle movement dynamics of the motor vehicle which are detected by means of sensors, the actuation of the safety-related component being carried out as a function of at least one predefined and adaptable threshold value which characterizes vehicle movement dynamics which are critical for driving safety, in such a way that a risk of injury to a vehicle occupant and/or another party to a collision is reduced. According to the invention, the adaptation of the threshold value is coupled to the driver-end power request in such a way that the actuation of the safety-related component does not take place until vehicle movement dynamics which result from the current driver-end power request and are critical for safety are evaluated as a driving state which is brought about in a random and uncontrolled fashion. Furthermore, the invention relates to a motor vehicle which is actuated in this manner.

### BACKGROUND AND SUMMARY OF THE INVENTION

This invention relates to a method for controlling at least one safety-related component of a motor vehicle, and to a passenger car having at least one safety-related component which can be actuated by means of a control device.

Motor vehicles known from practice, in particular passenger cars, are embodied with active and passive safety devices, which support a driver in such a way that he can better control his vehicle even in driving situations which are critical for safety, which protect the body of the vehicle occupants, and which, if appropriate, protect other parties in an accident.

Particular importance is paid here to safety systems which trigger in a preventative fashion, which are also known as PRE-SAFE systems (registered trademark), and which are already effective in a preventative fashion before a possible collision. Such systems use the time period from the detection of a high probability of an accident by appropriate detection systems up to the actual impact to extend vehicle occupant protection by additional safety measures and thus reduce the severity of the accident. In this context, in order to detect possible accident situations, information is used which may be made available by various sensor devices of the motor vehicle which may be, for example, components of an electronic driving stability program. Depending on the detected situation, conclusions are then drawn about a possible impact, and corresponding measures are initiated in order to condition the vehicle and restraint systems for vehicle occupants on the imminent occurrence of an accident.

A PRE-SAFE system in which driving state data is recorded by means of a sensor system and which has a reversible vehicle occupant protection system which can be activated before the time of a collision and thus placed in the operative position is known from German document DE 101 21 386 C1. The driving state data are monitored here by means of a sensor system for any emergency braking, any oversteering or possible understeering. If emergency braking, oversteering and/or understeering are/is detected, the vehicle occupant protection system is activated, it being possible to trigger the vehicle occupant protection system only when a minimum speed is exceeded. The sensor system for detecting the vehicle state data can comprise a steering angle sensor, a pedal travel sensor, a brake pressure sensor, a wheel speed sensor, an acceleration sensor, and a yaw rate sensor.

However, the vehicle occupant protection system known from German document DE 101 21 386 C1 is disadvantageously always activated at the same triggering value, for which reason, at low vehicle speeds, it has a comparatively sensitive triggering behavior and, at high vehicle speeds, it has a comparatively insensitive triggering behavior.

German document DE 100 29 061 A1 discloses a vehicle occupant protection system having an electromotive seatbelt pretensioner for pretensioning a seatbelt and having a control device for actuating the seatbelt. The control device determines whether a potential accident situation is present as a function of operating state variables which characterize vehicle movement dynamics such as a vehicle speed, a yaw angle, a yaw acceleration, lateral acceleration and longitudinal acceleration and actuating variables such as pedal travel, pedal force or vehicle steering angle. The abovementioned operating state variables are evaluated in order to produce corresponding threshold values for the indicator signals which are provided in order to determine a potential accident situation, or to change said threshold values. If the actual driving behavior of the vehicle which is derived from the indicator signals deviates from the desired driving behavior, a potential accident situation is detected by an evaluation device and the electric pretensioner drive is actuated in order to pretension the seatbelt.

Furthermore, there is provision for the threshold values to be adapted by means of a self-learning logic as a function of the braking activity and acceleration activity of the respective driver. In addition it is proposed to adapt the threshold values as a function of the respective vehicle speed in the evaluation device in order to bring about adaptation to the driving style of the driver, for example to sporty or dynamic driving or to a slow, relaxed driving style. In order to set the threshold values, the corresponding memory locations of a threshold value accumulator can be connected to a self-learning logic. This self-learning logic records the individual driving habits of the motor vehicle driver, in particular with respect to braking activity and acceleration activity.

In such a vehicle occupant protection system, undesired triggering processes of vehicle occupant protection means can disadvantageously occur, i.e. for example the seatbelt is pretensioned without the driving situation requiring it, and in particular without this appearing appropriate to the driver or other vehicle occupants. This is initially also not prevented by the threshold values which can be adapted by means of the self-learning logic and can thus be changed, since undesired triggering processes are only avoided, if at all, after a certain adaptation time when driving situations occur which are critical in terms of safety and are intentionally brought about by a driver.

The present invention is therefore based on the object of making available a method for controlling at least one safety-related component of a motor vehicle as well as a motor vehicle having at least one safety-related component which can be actuated by means of a control device, it being possible to use said method and motor vehicle to reduce a number of undesired triggering processes compared to the vehicle systems which are known from the prior art.

According to the invention, this object is achieved with a method or with a motor vehicle as claimed.

The method according to the invention for controlling at least one safety-related component of a motor vehicle provides the possibility of preventing undesired and/or unnecessary actuation of the safety-related component, or at least of preventing the probability thereof so that the driver, and also other vehicle occupants or possible other parties in the collision such as, for example, a pedestrian, are not confused or unnecessarily bothered.

This is achieved in that the adaptation of the threshold value is coupled to the driver-end power request in such a way that the actuation of the safety-related component does not take place until vehicle movement dynamics which result from the current driver-end power request and are critical for safety are evaluated as a driving state which is brought about in a random and uncontrolled fashion.

This means that the threshold value is preferably changed as a function of a position of an accelerator pedal in such a way that actuation of the safety-related component is avoided, for example in the case of a sporty driving style in which triggering thresholds, which are predefined under certain circumstances, for understeering or oversteering are exceeded without a driving situation which is critical in terms of safety actually occurring.

In one preferred embodiment of the method according to the invention, the threshold value can be adapted by means of any desired function, for example a ramp function or else a jump function.

In one developed variant of the method according to the invention, it is possible to allow for the fact that a driver who is actually in a critical driving situation has a high probability of reducing a power request by preferably reducing the accelerator pedal angle, or of even carrying out a braking operation when the accelerator pedal is not activated.

This is in turn achieved by that the fact that the actuation of the component which reduces the risk of injury takes place during the presence of vehicle movement dynamics which are critical in terms of safety and when a predefined and preferably adaptable driver-end reduction in the power request is exceeded, since the threshold value is lowered in a corresponding way so that the threshold value is exceeded and the component is actuated.

In a motor vehicle embodied according to the invention, the number of undesired triggering processes is advantageously reduced compared to motor vehicles which are embodied in a conventional way.

This advantage is achieved by virtue of the fact that the threshold value is adapted as a function of a driver-end power request in such a way that the component is actuated only if vehicle movement dynamics which are detected correspond to a driving state which is brought about in a random and uncontrolled fashion.

In the present case, the term vehicle movement dynamics is understood to apply to the area of technical mechanics, i.e. vehicle mechanics, which is concerned with the forces acting on a vehicle and the vehicle movements resulting therefrom, it being possible basically to divide vehicle movement dynamics into longitudinal dynamics, lateral dynamics and vertical dynamics. In this context, longitudinal dynamics is concerned with the interaction of drive forces or braking forces at the wheels and with the driving resistance as a function of the conditions on the route and the operating conditions. Lateral dynamics considers the forces such as side wind or centrifugal forces, which divert the vehicle from the direction of travel. These forces can be compensated only by lateral guiding forces of the tires or wheels, in which case the wheel with a rubber tire rolls with a corresponding castor angle compared to its central plane. The dynamic wheel load, the drive forces and braking forces as well as the frictional properties of the carriageway are also of influence. Depending on the position of the center of gravity, the point of engagement of the wind forces, the structure of the wheel suspension and the condition of the tire, driving properties result which, together with the steering reactions of the driver allow the driving behavior, the direction of travel behavior when traveling straight ahead and the driving stability when cornering to be determined. The vertical dynamics investigates the perpendicular forces and movements which are generated by the unevennesses of the road and, with the interconnection of tire and vehicle suspension systems, generate lifting oscillations and pitching oscillations about the transverse axis, which are reduced using oscillation dampers. In the case of cornering, rolling which is dependent on the arrangement of the axles occurs about the longitudinal axis and can be influenced by stabilizers.

By using electronic control systems, attempts are made to improve the vehicle movement dynamics, it being possible to influence the longitudinal dynamics using, for example, an antilock brake system, the lateral dynamics using, for example, a vehicle movement dynamics controller with selective influencing of the yaw moments by means of a braking intervention, and the vertical dynamics by reducing the rolling pitch of the vehicle body and influencing the damping properties by electronic chassis control.

Furthermore, the term “safety-related component” constitutes here a generic term for vehicle components by means of which it is either possible to influence the movement dynamics of the motor vehicle in terms of crash behavior in the way described above, or by means of which safety of a vehicle occupant or of a party in a collision can be improved. For example, the vehicle components can also be embodied as vehicle occupant protection means which can be actuated, such as customary restraint means, which produce a restraining effect and/or an energy-absorbing effect in order to protect a vehicle occupant in the event of a collision. Examples of this are seatbelt pretensioners, airbags, a seat adjustment means, movable impact elements, cushions and headrests whose size, hardness, shape and position can be changed by actuation. Of course, the term safety-related component also includes what are referred to as third-party protection means such as an engine bonnet whose pitch can be adjusted or an extendable pedestrian impact damping element. An actuation process to close a sunroof or side windows into a position which is optimum in terms of a collision also constitutes a safety-related component within the meaning of the invention.

Further advantages and advantageous configurations of the subject matter according to the invention can be found in the description, the drawing and the patent claims.

The drawing is a basic illustration of an exemplary embodiment of the invention which will be explained in more detail in the following description.

### BRIEF DESCRIPTION OF THE DRAWINGS

FIG. 1 shows an exemplary embodiment of a motor vehicle which is configured according to the invention, and

FIG. 2 is a shortened block circuit diagram of a control device of a PRE-SAFE system of the motor vehicle in FIG. 1.

### DETAILED DESCRIPTION OF THE INVENTION

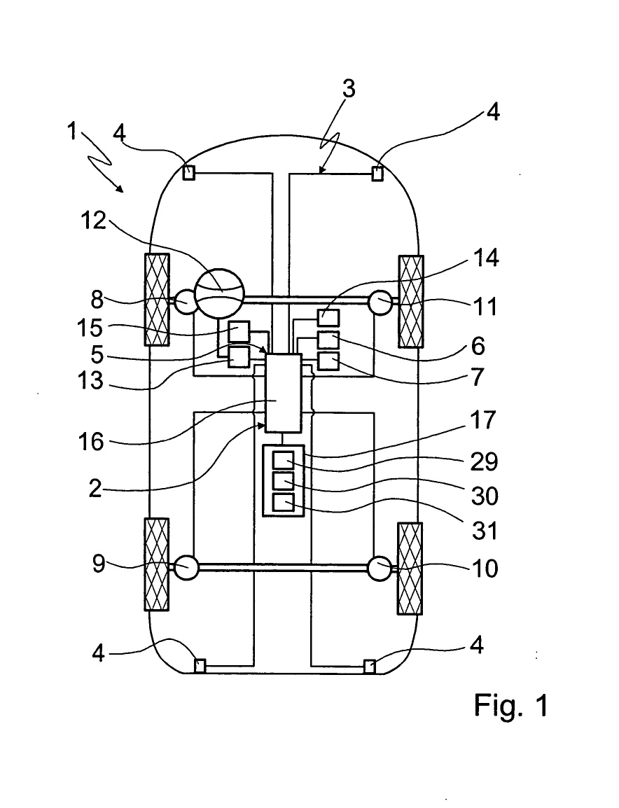

FIG. 1 is a highly schematic plan view of a motor vehicle 1, which can be embodied as a passenger car or else as a utility vehicle and is equipped with a PRE-SAFE system 2.

The PRE-SAFE system 2 has a safety sensor system 3 which interacts with a vehicle-surrounding detection device 4 and a driving-situation recording device 5. The driving-situation recording device 5 is in turn provided with a driving state sensor system 6, which serves, inter alia, for detecting oversteering and/or understeering of the motor vehicle 1. Inter alia, information and data supplied by wheel speed sensors 8, 9, 10 and 11, by a steering angle sensor 13 which is arranged in the region of a steering wheel 12, by a longitudinal acceleration sensor 14 and by a lateral acceleration sensor 15 are used for this purpose.

The driving state sensor system 6 is also assigned to a vehicle movement dynamic functionality 7 such as, for example, an antilock brake system and/or an electronic stability program. For these purposes, in the normal operating mode of the motor vehicle the driving state sensor system 6 can analyze further important vehicle movement dynamics variables such as, for example, a vehicle speed, a yaw rate, a spring compression travel and spring extension travel, the ride level of the vehicle, an accelerator pedal movement, an accelerator pedal position, a brake pedal position, a brake pedal movement, a steering wheel speed and/or a steering wheel acceleration. In the process, actual values of these variables are compared with predefined set point values and threshold values. For example, the antilock brake system and/or the electronic stability program are activated on the basis of these comparisons.

The longitudinal and lateral accelerations which are determined by the sensors 14 and 15 and the respective vehicle speed which is determined by means of the wheel speed sensors 8 to 11 are evaluated in a data evaluation device 16 in order to use or activate the PRE-SAFE system 2, a comparison being carried out with a threshold value. This means that when the threshold value or triggering threshold value is exceeded, the PRE-SAFE system 2 is activated and at least one selection of safety devices 17 which are present in the motor vehicle is actuated. In the present case, the safety devices comprise in particular airbags 29, a seatbelt pretensioner 30 and actuation of an electronic seat adjustment device 31, which all constitute safety-related components within the meaning of the invention.

The triggering algorithm which is stored in the data evaluation device 16 is configured in such a way that the triggering threshold value of the PRE-SAFE system 2 is adapted as a function of the position of an accelerator pedal. The triggering threshold value is adapted here at least essentially in a continuous fashion, specifically in such a way that it is increased as the accelerator pedal angle increases. This means that when the accelerator pedal angle is large, the PRE-SAFE system 2 is only activated at a high triggering threshold value.

All the safety devices 17, or individual safety devices 17, are activated when the data evaluation device 16 determines the possibility of the motor vehicle 1 being involved in an accident, for example as a result of the vehicle veering off owing to unacceptably high operating state variables of the vehicle movement dynamics, on the basis of the information detected by means of the driving state sensor system 6 and/or by the vehicle-surrounding detection device 4. In particular, the information about the condition of the underlying surface, i.e. about the coefficient of friction of the underlying surface, is of decisive importance here also.

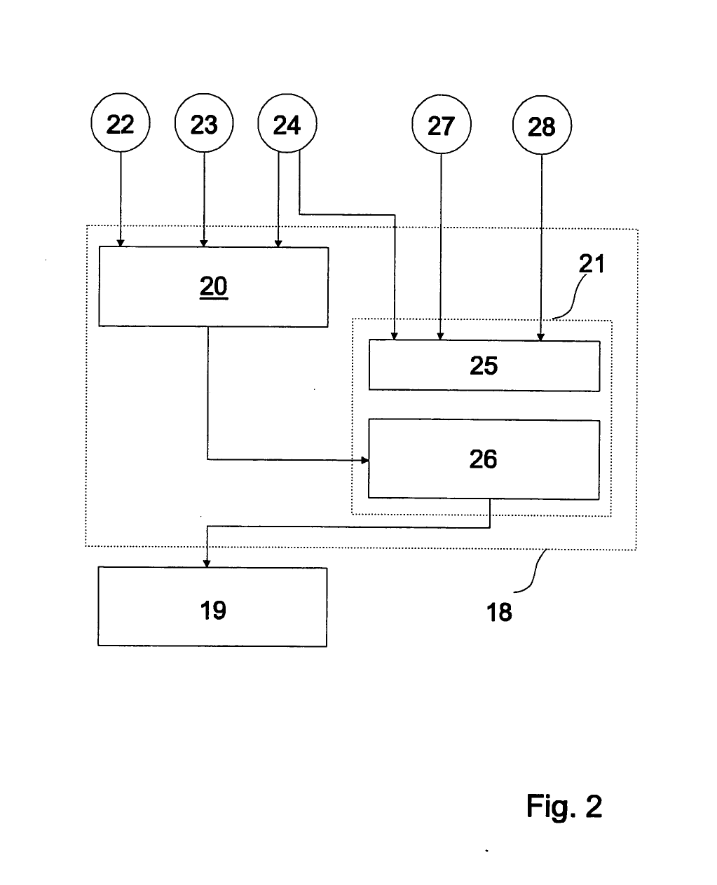

FIG. 2 is a block circuit diagram of a control device 18 for actuating a vehicle occupant protection means 19 which constitutes a safety-related component. The control device 18 comprises a decision stage 20 and an evaluation stage 21.

The decision stage 20 records variables 22, 23 and 24, in particular vehicle movement dynamics variables which originate, for example, from control units and sensors such as an ABS controller, a wheel speed sensor, a yaw rate sensor or a surrounding sensor. By means of the recorded variables 22, 23, 24 the decision stage 20 determines whether driving behavior of the vehicle which is critical in terms of safety is occurring and if appropriate it outputs a triggering decision, corresponding to the driving behavior which is critical in terms of safety, for the vehicle occupant protection means 19. The triggering decision can be composed of a simple signal for activating the vehicle occupant protection means 19 or additionally comprise the triggering time, the triggering characteristic, the triggering speed, the triggering intensity and the actuation period of the vehicle occupant protection means 19.

The evaluation stage 21 comprises a first substage 25 for determining a desired driving behavior, i.e. a driving behavior of the vehicle which is brought about in an intentional and controlled fashion by the driver, and a second substage 26 for evaluating the triggering decision as to whether or not the vehicle occupant protection means 19 is to be actuated.

In order to determine the desired driving behavior, the first substage 25 uses variables 24, 27, 28 recorded in the vehicle, such as for example the steering angle, the wheel speeds, the accelerator pedal travel and brake pedal travel and the yaw rate and/or the profile of these variables over time. In particular, for the evaluation it is also possible to use variables which are not taken into account by the decision stage 20. The desired driving behavior which is determined is transferred to the second substage 26.

The second substage 26 records the desired driving behavior which is determined by the first substage 25, and the driving behavior which is critical in terms of safety which has been transferred by the decision stage 20, and it compares whether the desired driving behavior corresponds, within predefinable limits, to the driving behavior which is critical in terms of safety. If this is the case, the second substage 26 evaluates the triggering decision based on the driving behavior which is critical in terms of safety as being implausible, and prevents actuation of the vehicle occupant protection means 19 on the basis of this triggering decision.

The first and second substages can also be configured as a single stage which uses the recorded variables 24, 27, 28 and the triggering decision determined by the decision stage 20 and/or the driving behavior which is critical in terms of safety which has been determined.

If the triggering decision is classified as plausible by the evaluation stage 21 or if at least the plausibility which is determined is high enough, this leads to the triggering decision being enabled and to actuation of the vehicle occupant protection means 19. The actuation can be carried out directly by the evaluation stage 21.

As an alternative to this, the evaluation stage 21 enables direct actuation of the vehicle occupant protection means 19 by the control device 18, in particular by the decision stage 20 or a control stage which is provided for that purpose.

In particular an output signal of a vehicle movement dynamics control system and/or an output signal of a braking assistance system are used as the input signal of the decision stage 20. For example, a triggering decision is made when a predefinable signal of a vehicle movement dynamics control system and/or of a braking assistance system is registered.

An essential feature in the inventive evaluation of the triggering decision is the detection of a driving behavior of the motor vehicle 1 which is brought about by the driver in a voluntary and controlled fashion and in the process in particular the differentiation of a driving behavior which is brought about by the driver in a voluntary fashion from a driving behavior which is based on reflex actions and fast reactions and/or from a driving behavior which is not actively brought about by the driver.

It is particularly advantageous if the evaluation of the current vehicle movement dynamics takes place quickly. In order to permit very rapid evaluation, there is provision for a desired driving behavior to be determined in parallel with or at least virtually simultaneously with the triggering decision by considering a limited, preceding time period of, for example, 5 s or 1 min, i.e. using operating state variables which are recorded in this time period or describe this time period. As a result, a triggering decision can reliably be made in real time, i.e. without a significant delay.

In order to check whether the driving behavior which is critical in terms of safety is a desired driving behavior which is requested by the driver and brought about in a controlled fashion, use is made in particular of control variables and actuating variables which are predefined by the driver, such as for example steering angle and pedal position and in particular the change in the control variables and actuating variables over time, as well as system settings which are predefined by the driver, such as for example the status or the switching on and off of a traction controller or of a vehicle movement dynamics control system. Driver and route-related variables such as driving style or customary selection of a route can also be used to determine the desired driving behavior.

In particular, a desired driving behavior can be determined from the profile of activation of an accelerator pedal over time, for example from the amplitude, the frequency or the speed of a change in the accelerator pedal position over time, and here particularly from the speed of release of the accelerator pedal and from a time period between release of the accelerator pedal and activation of the brake pedal. Fast release of the accelerator pedal can be evaluated by the driver as the presence of the detection of a risk, with which the driving situation which is critical in terms of safety is to be evaluated as no longer corresponding to the driver's wishes. Triggering the safety devices 17 or the vehicle occupant protection means 19 is thus plausible in such a situation.

The undesired presence of a driving situation which is critical in terms of safety can also be determined by evaluating sensors which record body reactions and which are known per se for recording an emergency situation or stress situation, for example by sensing a transpiration behavior, a heartbeat or change in the pupils.

Furthermore, current vehicle movement dynamics can be evaluated by taking into account the driver-end power request by considering a changeover time in a variable which characterizes the vehicle movement dynamics. This means that vehicle movement dynamics are evaluated as a driving behavior which is brought about in an intentional and controlled fashion if the changeover time in the variable which characterizes the vehicle movement dynamics drops below a predefinable threshold of speed of change. For example, in the case of a slow yaw rate, i.e. one which does not change suddenly and increases over a relatively long time of, for example, several seconds, a triggering decision on the basis of a recorded yaw rate value which is above a threshold value is rejected as implausible since a driving state which is brought about by the driver in a voluntary and controlled fashion is determined. On the other hand, uncontrolled changes in the driving state, for example changes in the driving state which surprise the driver, continue to lead to triggering of the vehicle occupant protection means 19.

In one advantageous variant of the method according to the invention, current vehicle movement dynamics indicate a driver's requested driving behavior if a comparable driving situation occurs with a predeterminable frequency within a predeterminable time interval. If, for example, an emergency braking operation occurs for the third time within a time interval of two minutes, with the initial speed at the start of the braking being between 60 and 80 km/h in each case, a driver's requested driving behavior is determined.

Likewise, understeering or oversteering and further driving states which are critical in terms of safety with other initial speed ranges do not lead to actuation of the safety-related components. A precondition for this is that a predefinable number of repetitions of a driving situation which is critical in terms of safety occurs within a predefinable time period.

In order to increase the reliability of an evaluation of the current vehicle movement dynamics, further criteria may be additionally checked. For example, in the case of an emergency braking situation which occurs repeatedly within a few minutes, it is possible to additionally check whether the steering angle of the yaw rate has an identical or at least a similar value in each emergency braking situation. Only if this is the case is a driver's requested driving situation determined and the actuation of the safety-related components, which would take place on the basis of the emergency braking situation, does not occur.

Furthermore, there is the possibility of defining special driving situations so that when a predefined special driving situation occurs, the safety-related components are prevented from being actuated. The occurrence of a special driving situation can be detected, for example, by means of a predefinable vehicle movement dynamic pattern which is characteristic of this special driving situation. A predefinable vehicle movement dynamic pattern means that a value range is defined for a set of vehicle movement dynamics variables and the values of various vehicle movement dynamics variables have a fixed relationship to one another, that is to say the value ranges have a predefinable relationship. Alternatively or in addition to this it is also possible to characterize special driving situations for this purpose by means of actuating variables such as the steering angle and position of the accelerator pedal.

Furthermore, special driving situations can also be defined by means of ambient variables such as, for example, by means of the external temperature, the conditions of the road, the coefficient of friction between the road and underlying surface, the position of the vehicle which is recorded by means of a position-sensing system, the distance from a vehicle traveling in front or from objects in the surroundings of the vehicle or the type of road (motorway, village street etc.). As a function of these variables it is possible to determine whether the driving behavior which is critical in terms of safety corresponds to a desired driving behavior.

1-10. (canceled)

11. A method for controlling at least one safety-related component of a motor vehicle as a function of vehicle movement dynamics of the motor vehicle which are detected by sensors, actuation of the safety-related component being carried out as a function of at least one predefined and adaptable threshold value characterizing vehicle movement dynamics that are critical for driving safety in such a way that a risk of injury to a vehicle occupant, another party, or both the vehicle occupant and the other party in a collision is reduced, comprising:
evaluating a driver-end power request, and
coupling adaptation of the threshold value to the driver-end power request in such a way that the actuation of the safety-related component does not take place until vehicle movement dynamics, which result from the driver-end power request and are critical for safety, are evaluated as a driving state which is brought about in a random and uncontrolled fashion.

12. The method as claimed in claim 11, wherein a signal which is proportional to a position of an accelerator pedal is used to evaluate the driver-end power request.

13. The method as claimed in claim 11, wherein the actuation of the safety-related component takes place when a driver-end reduction in the power request is exceeded while the vehicle movement dynamics that are critical for safety are present.

14. The method as claimed in claim 13, wherein the safety-related component is actuated as a function of a gradient of the reduction in the power request.

15. The method as claimed in claim 11, wherein the actuation of the safety-related component is carried out as a function of a body reaction by a driver which indicates an emergency situation, a stress situation, or both emergency and stress situations.

16. The method as claimed in claim 11, wherein the safety-related component is actuated as a function of a time period between release of a power request element and activation of a brake pedal.

17. The method as claimed in claim 11, wherein the threshold value is adapted by means of a jump function.

18. The method as claimed in claim 11, wherein the threshold value is adapted by means of a ramp function.

19. The method as claimed in claim 12, wherein the actuation of the safety-related component takes place when a driver-end reduction in the power request is exceeded while the vehicle movement dynamics that are critical for safety are present.

20. The method as claimed in claim 19, wherein the safety-related component is actuated as a function of a gradient of the reduction in the power request.

21. The method as claimed in claim 12, wherein the actuation of the safety-related component is carried out as a function of a body reaction by a driver which indicates an emergency situation, a stress situation, or both emergency and stress situations.

22. The method as claimed in claim 12, wherein the safety-related component is actuated as a function of a time period between release of a power request element and activation of a brake pedal.

23. The method as claimed in claim 12, wherein the threshold value is adapted by means of a jump function.

24. The method as claimed in claim 12, wherein the threshold value is adapted by means of a ramp function.

25. The method as claimed in claim 13, wherein evaluating the driver-end power request includes determining a desired driving behavior from a profile of accelerator pedal actuation over time.

26. The method as claimed in claim 13, wherein evaluation of the driving state which is brought about in a random and uncontrolled fashion is determined by fast release of an accelerator pedal.

27. The method as claimed in claim 11, wherein the vehicle movement dynamics that are critical for safety are lateral vehicle movement dynamics.

28. The method as claimed in claim 13, wherein the vehicle movement dynamics that are critical for safety are lateral vehicle movement dynamics.

29. A motor vehicle, comprising:
at least one safety-related component which can be actuated by a control device, the safety-related component being actuated as a function of operating state variables characterizing vehicle movement dynamics in order to reduce a risk of an accident and/or a risk of injury to a vehicle occupant and/or another party in a collision,
sensors by which said vehicle movement dynamics are detected, and
a data evaluation device by which said vehicle movement dynamics are evaluated,
wherein the operating state variables are compared with at least one threshold value,
wherein the safety-related component is actuated when the threshold value is exceeded, and
wherein the threshold value is adapted as a function of a driver-end power request in such a way that the safety-related component is actuated only if vehicle movement dynamics which are detected correspond to a driving state which is brought about in a random and uncontrolled fashion.

30. The motor vehicle as claimed in claim 29, wherein the safety-related component is actuated as a function of detected lateral dynamics.
